(19) United States
(12) Patent Application Publication
(10) Pub. No.: US 2005/0055228 A1
(43) Pub. Date: Mar. 10, 2005

(54) Management method of in-flight entertainment device rentals having self-contained audio-visual presentations

(75) Inventors: William J. Boyer JR., Lakewood, WA (US); Robert Ray Henson, Spanaway, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Aircraft Protective Systems, Inc., Tacoma, WA (US)

(21) Appl. No.: 10/657,823

(22) Filed: Sep. 8, 2003

(51) Int. Cl. G06F 17/60

(52) U.S. Cl. 705/1; 705/5

(57) ABSTRACT

A management method of in-flight entertainment device (IFED) rentals having self-contained audiovisual presentations is disclosed. A self-contained IFED has internal storage configured to contain current releases of movies and other audiovisual presentations. The method addresses aspects related to servicing distribution, and collection of the self-contained IFEDs.

### BACKGROUND OF THE INVENTION

1. Field of the Invention

The present invention is directed generally to management of device rentals and, more particularly, to management of entertainment devices having self-contained audio-visual presentations for rent to passengers of conveyances such as commercial airline flights.

2. Description of the Related Art

Rental of entertainment devices having self-contained audio-visual presentations to be used by passengers during a commercial airline flight can provide individually tailored current entertainment and other services to the passengers during the commercial flight. Unfortunately, conventional management methods have not addressed such self-contained in-flight entertainment device rentals. Consequently, prior support for their implementation has not been available.

### BRIEF SUMMARY OF THE INVENTION

The present invention resides in a management method of in-flight entertainment device rentals having self-contained audio-visual presentations. Aspects include accepting a reservation for rental of a self-contained in-flight entertainment device for use on a commercial airline flight of an aircraft. The aspects further include adding the reservation to a manifest containing at least a count of self-contained in-flight entertainment devices reserved for the commercial airline flight and comparing the count of self-contained in-flight entertainment devices reserved for the commercial airline flight with a default number indicating how many in-flight entertainment devices are stored on board the aircraft. Aspects further include if the count of self-contained in-flight entertainment devices reserved for the commercial airline flight is larger than the default number by a difference, then bringing on board the aircraft before the commercial airline flight commences an additional number of self-contained in-flight entertainment devices at least as large as the difference.

Other features and advantages of the invention will become apparent from the following detailed description, taken in conjunction with the accompanying drawings.

### BRIEF DESCRIPTION OF THE SEVERAL VIEWS OF THE DRAWING(S)

FIG. 1 is a side-view of a passenger viewing an audio-visual presentation being presented by a representative self-contained in-flight entertainment device (IFED) rental while traveling during a commercial flight.

FIG. 2 is a perspective view of the self-contained IFED of FIG. 1.

FIG. 3 is a top cross-sectional schematic view of a top deck of a commercial aircraft generally showing location of seating and storage areas accessible by flight attendants.

FIG. 4 is a side cross-sectional schematic view of a top and bottom deck of the commercial aircraft of FIG. 3 showing location of seating, storage areas accessible by flight attendants, and storage areas accessible only on the ground.

FIG. 5 is a top cross-section view of a portion of an airport facility showing various pertinent locations described herein.

FIG. 6 is a front elevational view of a supply truck being docked with an aircraft.

FIG. 7A is a top plan view of an implementation of a carrying case used to transport a plurality of the IFEDs of FIG. 1.

FIG. 7B is a cross-sectional side view of the carrying case of FIG. 7A.

FIG. 8 is a flowchart of an implementation of a method of reservation based management for self-contained IFED rentals.

FIG. 9 is a flowchart of an implementation of a method of management of self-contained IFED rentals for impulse use.

### DETAILED DESCRIPTION OF THE INVENTION

A management method of in-flight entertainment device (IFED) rentals having self-contained audiovisual presentations is disclosed herein. A self-contained IFED has internal storage configured to contain current releases of movies and other audiovisual presentations. According to implementations of the present method, the self-contained IFED can be rented by passengers of commercial airline flights for viewing of such movies and other audiovisual presentations during the flight. Use of the self-contained IFED provides a selection of audiovisual presentations from which the passengers renting the self-contained IFED can choose. This individualizes the selection opportunity provided to each passenger by the self-contained IFED and increases the potential for enjoyment by the passengers compared with conventional systems that display one audiovisual. presentation to a large group of passengers with the passengers having no input on the particular audiovisual property being presented.

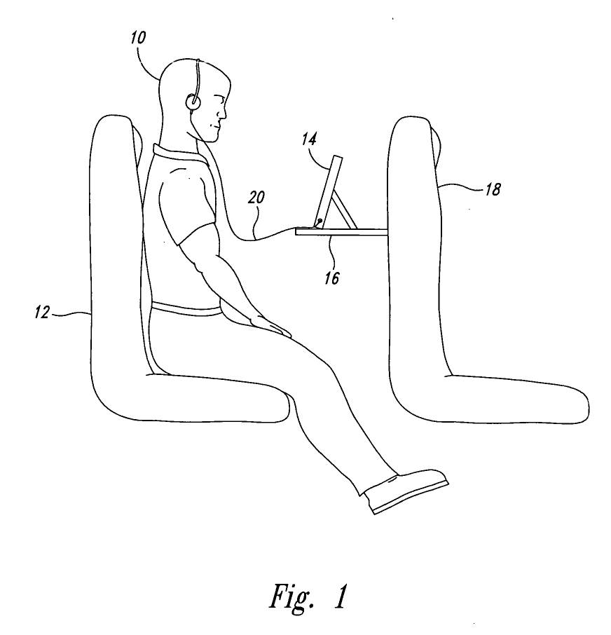

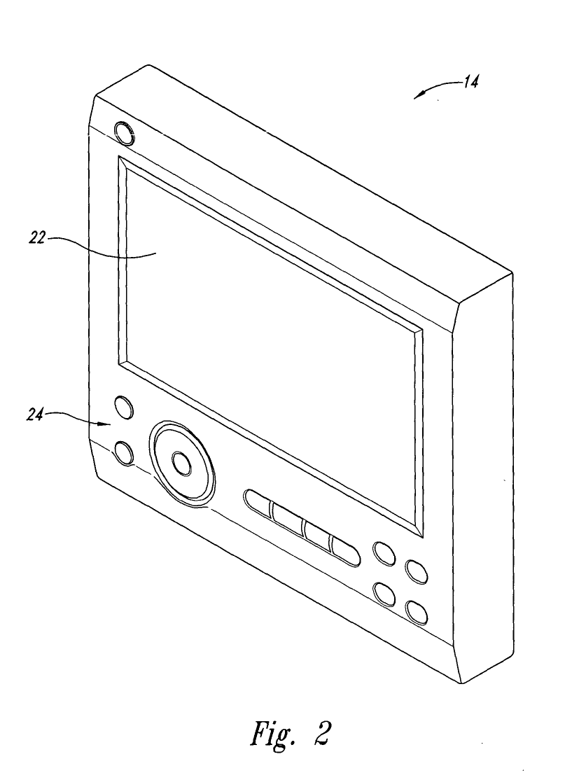

As shown in FIG. 1, a passenger 10 while seated in aircraft seat 12 can view a movie being presented by a self-contained IFED 14 resting on a seat back table 16 that is connected to a forwardly adjacent aircraft seat 18. As is conventional practice, earphones 20 can be used to listen to the audio portion of the presentation without disturbing fellow passengers. The self-contained IFED 14, further depicted in FIG. 2, includes a display 22 for viewing presentations and controls 24 for selection of presentations and adjustment of the self-contained IFED.

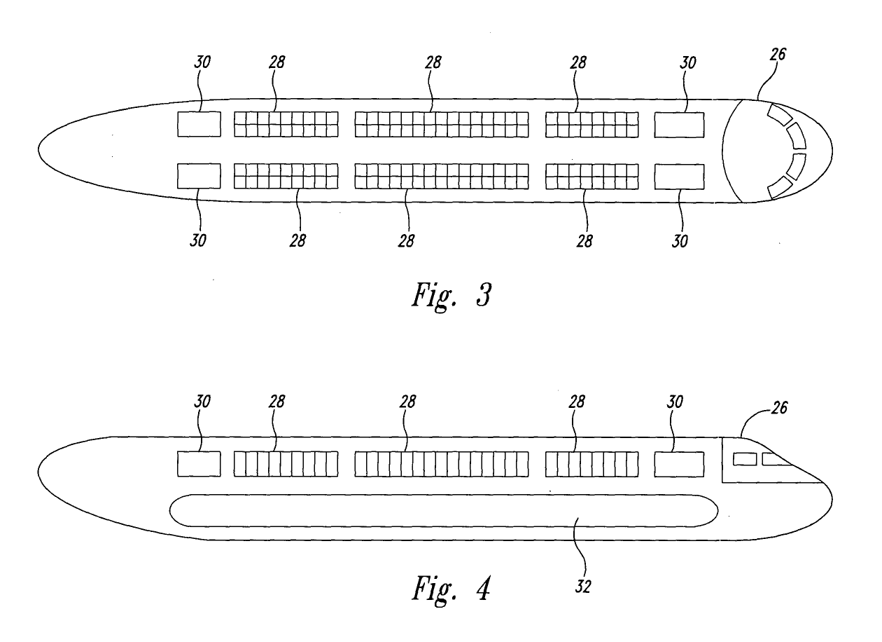

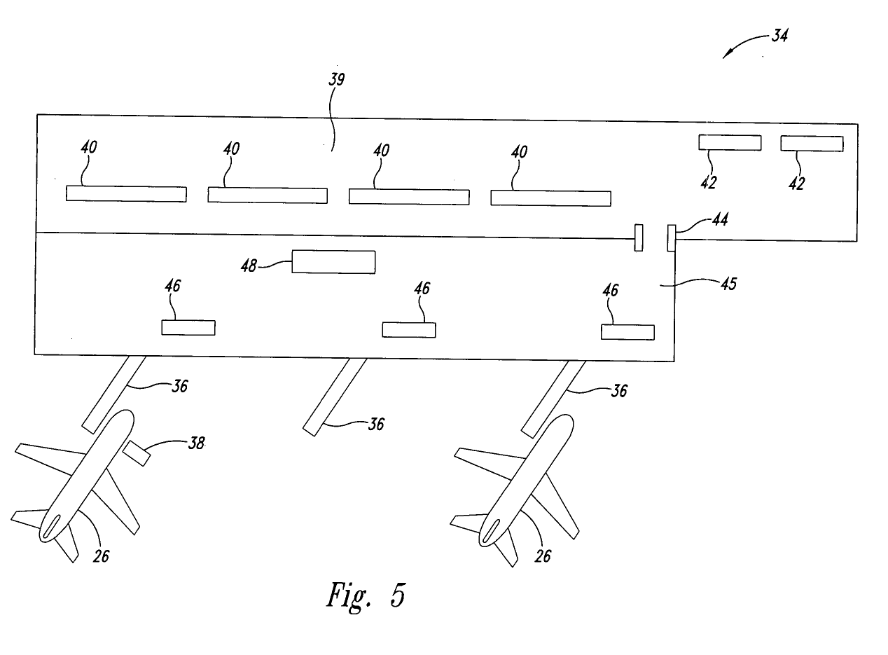

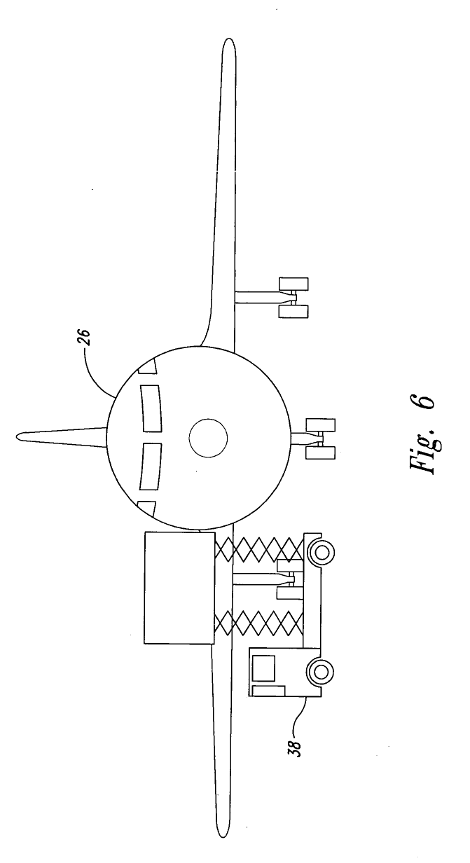

A representative aircraft 26, shown in FIG. 3, includes passenger seats 28 and in-flight storage 30 accessible by flight attendants (not shown) during flight of the aircraft. As shown in FIG. 4, the representative aircraft 26 also includes ground-only accessible storage 32 generally configured to contain luggage and other items to be loaded and unloaded by ground crew when the aircraft is parked at an airport. A representative portion of an airport 34 is shown in FIG. 5 as having terminal gates 36 at which pluralities of the aircraft 26 can park to load and/or unload passengers, luggage, food, refuse, and fuel. A conventionally known supply truck 38 is shown in FIGS. 5 and 6 docked with one of the aircraft 26 typically for delivery of food and others items that will be consumed or otherwise used during flight.

The airport 34 has a low security area 39 being accessible by the public without being examined by metal detectors and other security devices. The low security area 39 includes conventionally known ticket counters 40 and miscellaneous counters 42 such as for car rentals. A security checkpoint 44 having conventionally known screening equipment such as metal detectors and x-ray machines provides access to a high security area 45 to airline passengers. The high security area 45 includes conventionally known gate counters 46 near each of the terminal gates 36 and in some implementations, a kiosk counter 48 which, as will be described below may be used for rental pickup of the self-contained IFEDs by individual passengers.

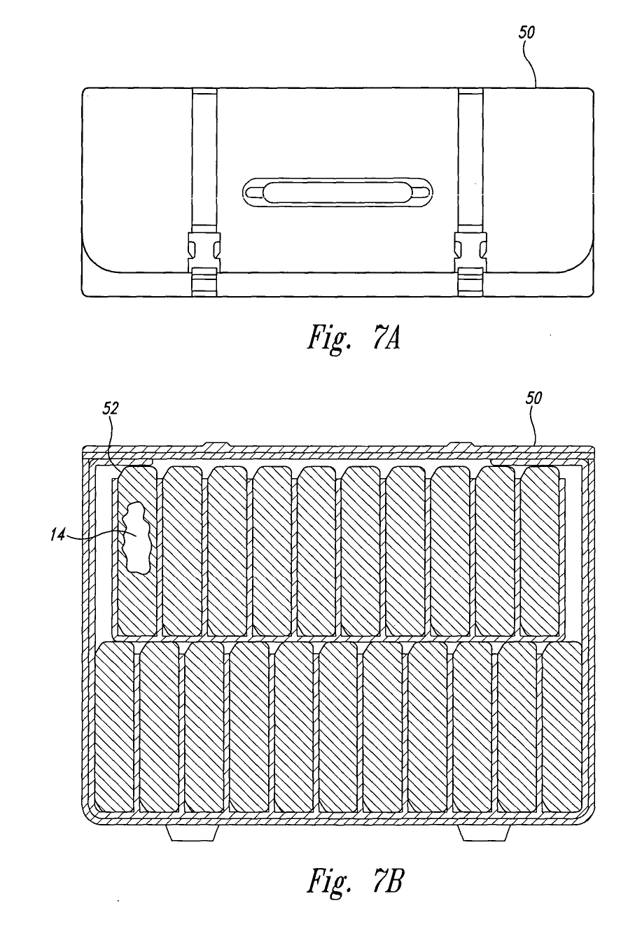

An IFED carrying case 50, shown in FIGS. 7A and 7B, is constructed for hand carry transport of a large number of the self-contained IFEDs 14 to distribution points such as the kiosk counter 48. Each of the self-contained IFEDs 14 is first placed in an individual pouch 52 before being placed in the IFED carrying case 50.

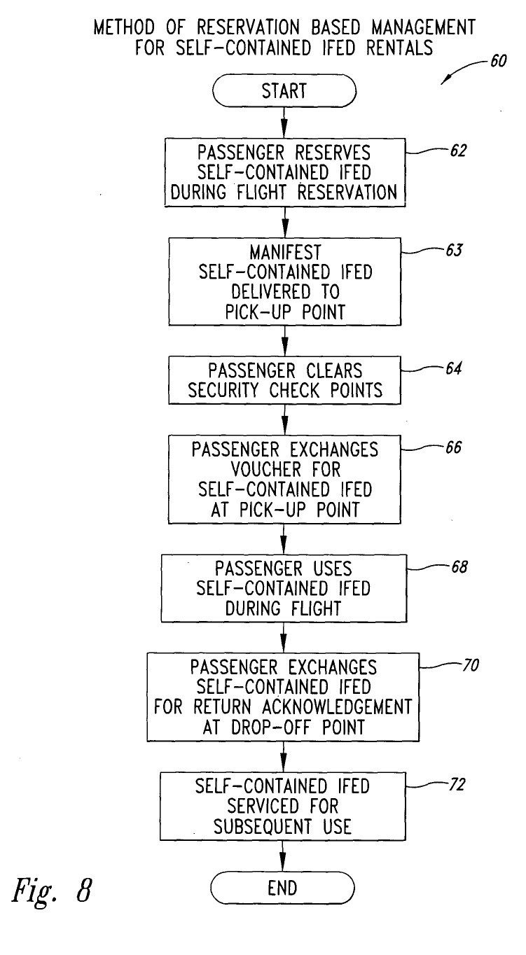

A method 60 of reservation based management for self-contained IFED rentals is shown in FIG. 8 as starting with one of the self-contained IFEDs 14 being reserved as part of a flight reservation (step 62) done by telephone, Internet access, at a travel agency, or by other means used for reserving and booking commercial aircraft flights. In some implementations, the passenger 10 subsequently receives a IFED voucher along with a flight ticket either by mail, the Internet, local pickup, or other means. The IFED voucher is then used by the passenger 10 to acquire one of the self-contained IFEDs 14 at a pickup location. In other implementations, a passenger manifest indicating which of the passengers on a particular flight has reserved one of the self-contained IFEDs 14, is used in addition or in lieu of the IFED voucher. The passenger manifest is typically generated at a location where the self-contained IFED rentals are being managed. Prior to the flight, the passenger manifest is either electronically or physically delivered to a pickup location where the self-contained IFED will be transferred to the passenger, as are a number of the self-contained IFEDs 14 (step 63).

In some implementations, these pickup locations are typically configured to store one or more of the IFED carrying cases 50 containing a preselected number of the self-contained IFEDs 14 based upon a historical record of prior use for the commercial aircraft flight route or routes being serviced by the pickup location. If the manifest shows that more of the self-contained IFEDs have been reserved than are available at the pickup location then additional self-contained IFEDs are delivered to the pickup location (along with the manifest if the manifest is also delivered physically).

Depending upon implementation, the pickup location could be at various areas in the airport 34 or on the aircraft 26. Generally, pickup locations that are either in the high security area 45 (such as the gate counter 46 or the kiosk counter 48) or on the aircraft 26 may present less problems for the passenger 10, since the passenger has less to take through the security checkpoint 44. Other implementations use pickup locations outside of the high security area 45 such as in the low security area 39 (possibly using one of the miscellaneous counters 42) at the airport 34 or possibly a pickup location near the airport (possibly at a location of a nearby rental car agency).

In the method 60 depicted in FIG. 8, the pickup location is either in the high security area 45 or on the aircraft 26, so that the passenger 10 first goes through the security checkpoint 44 (step 64) before arriving at the pickup location. If the pickup location is on the aircraft 26, a convenient way of delivery of the self-contained IFEDs 14 to the storage areas 30 on the aircraft is through use of the supply truck 38 with ground crew such as catering personnel. Under the voucher system, the passenger 10 then presents the prior received voucher in exchange for one of the self-contained IFEDs 14 (step 66). According to some implementations, if provided, the passenger manifest is used at the pickup location to either verify the voucher based exchanges or in lieu of using a voucher.

In flight, the passenger 10 then uses the self-contained IFED 14 (step 68) as previously discussed regarding FIG. 1. After completion of use, the passenger 10 returns the self-contained IFED to a drop-off point in exchange for a return acknowledgement (step 70) typically in the form of a paper receipt or through electronic means such as through closing out a credit or debit card transaction. The drop-off point can be any of the locations mentioned as being the possible pickup locations, apart from noting that the pickup and drop-off locations are at or near the airports 34 of origination and destination, respectively.

After the self-contained IFED 14 is received at the drop-off location, it is serviced for subsequent use (step 72). If movies and other audiovisual presentations being stored on the self-contained IFED 14 are still current, the self-contained IFED is charged to boost stored electrical energy back to peak levels. The self-contained IFED 14 may also undergo diagnostic testing to check that it is operational within established parameters. If the self-contained IFED 14 has dated movies or other material, then the self-contained IFED is sent back to a central re-loading location to be re-loaded with up-to-date material and is replaced by another one of the self-contained IFEDs that already has up-to-date material loaded.

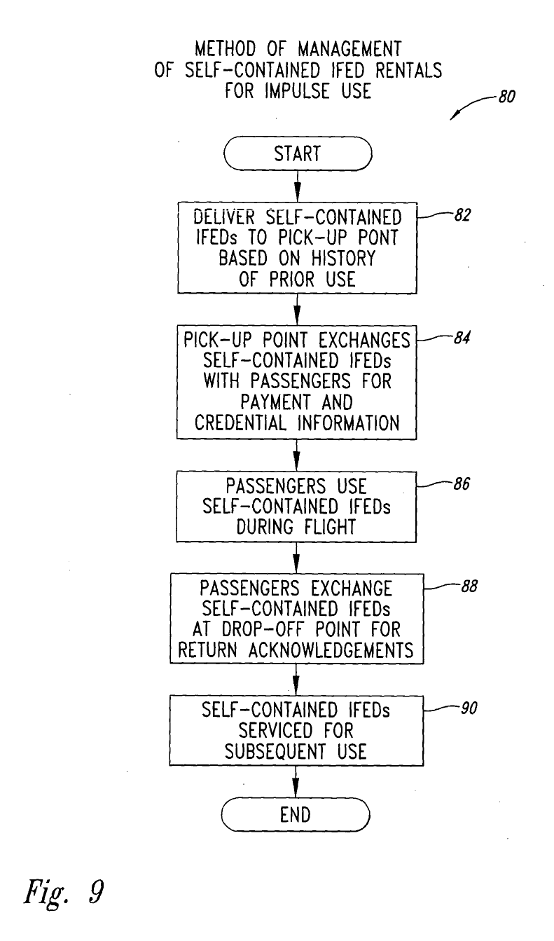

A method 80 of management of self-contained IFED 14 rentals for impulse use is shown in FIG. 9 as starting with delivery of a quantity of the self-contained IFEDs 14 to the pickup location with the number delivered being based upon historical records of prior use (step 82) typically using the carrying case 50. The method 80 can be implemented with various pickup locations found in the high security area 45 or the low security area 39 of the airport 34, on the aircraft 26, or possibly in pickup locations in areas other than the airport, as described above. When the pickup location is on the aircraft 26, typically flight attendants are used to hand out the self-contained IFEDs 14 to the passengers 10 requesting such after the passengers have been seated in the aircraft.

Generally, the pickup locations can store a sufficient inventory of the self-contained IFEDs 14 for typical demand, however, delivery of additional of the self-contained IFEDs can occur as needed if the inventory at the pickup location diminishes or as the audiovisual material being stored on the self-contained IFEDs currently being stored at the pickup locations becomes dated and IFEDs are removed for reloading. Exemplary rotation schedules for replacing the inventory of self-contained IFEDs 14 at the pickup locations can be for a period of 60 or 90 days. Other intervals are possible as well depending upon the factors such as the average frequency of passenger travel.

At the pickup location, the self-contained IFED 14 is exchanged with the passenger 10 for some form of payment and a satisfactory presentation of the passenger's credential information (step 84). The passenger 10 then uses the self-contained IFED 14 during the commercial flight (step 86). After use, the passengers 10 exchange their self-contained IFEDs 14 at the drop-off point for return acknowledgements (step 88). The drop-off point may be the aircraft 26 in which the passenger is flying and be accomplished while still on the aircraft before the end of the flight by returning the self-contained IFED to the flight attendant. The self-contained IFEDs 14 are then serviced in a manner similar to that described above for the method 60.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method comprising:
accepting a reservation for rental of a self-contained in-flight entertainment device for use on a commercial airline flight of an aircraft;
adding the reservation to a manifest containing at least a count of self-contained in-flight entertainment devices reserved for the commercial airline flight;
comparing the count of self-contained in-flight entertainment devices reserved for the commercial airline flight with a default number indicating how many in-flight entertainment devices are stored on board the aircraft; and
if the count of self-contained in-flight entertainment devices reserved for the commercial airline flight is larger than the default number by a difference, then bringing on board the aircraft before the commercial airline flight commences an additional number of self-contained in-flight entertainment devices at least as large as the difference.

2. The method of claim 1 further including delivering the manifest to the aircraft before the commercial airline flight commences.

3. The method of claim 1 wherein the reserving further includes reserving a commercial airline flight.

4. The method of claim 1 wherein the bringing is done by a catering service for the commercial airline flight wherein a supply truck delivers the additional number of self-contained in-flight entertainment devices to the aircraft.

5. A method comprising:
reserving for rental of one of a plurality of self-contained in-flight entertainment devices for use on a commercial airline flight of an aircraft;
receiving a voucher associated with the reserving;
exchanging the voucher for one of the plurality of self-contained in-flight entertainment devices;
using the self-contained in-flight entertainment device while flying on the commercial airline flight; and
exchanging the self-contained in-flight entertainment devices for a return acknowledgement.

6. The method of claim 5 wherein with the exchanging an electronic document or a paper document is used for the return acknowledgement.

7. The method of claim 5 wherein the receiving the voucher includes an electronic document or a paper document.

8. A method comprising:
accepting a reservation for rental of a self-contained in-flight entertainment devices for use by a person on a commercial airline flight of an aircraft; and
determining if any number of a plurality of self-contained in-flight entertainment devices stored on board the aircraft require deletion of stored audiovisual presentations and addition of other audiovisual presentations and if so, delivering a quantity of the other self-contained in-flight entertainment devices having the other audiovisual presentations stored to the aircraft for exchange with the any number of self-contained in-flight entertainment devices requiring deletion of store audiovisual presentations.

9. The method of claim 8 wherein the delivering is done by a catering service with a supply truck dockable with the aircraft.

10. A method comprising:
accepting a reservation for rental of a self-contained in-flight entertainment device for use on a commercial airline flight of an aircraft;
adding the reservation to a manifest containing at least a count of self-contained in-flight entertainment devices reserved for the commercial airline flight;
comparing the count of self-contained in-flight entertainment devices reserved for the commercial airline flight with a default number indicating how many in-flight entertainment devices are kept at a pickup location near origination of the commercial airline flight; and
if the count of self-contained in-flight entertainment devices reserved for the commercial airline flight is larger than the default number by a difference, then bringing to the pickup location before the commercial airline flight commences an additional number of self-contained in-flight entertainment devices at least as large as the difference.

11. A method comprising:
accepting a reservation for rental of a self-contained in-flight entertainment device for use on a commercial airline flight of an aircraft;
adding the reservation to a manifest containing at least a count of self-contained in-flight entertainment devices reserved for the commercial airline flight;
comparing the count of self-contained in-flight entertainment devices reserved for the commercial airline flight with a default number indicating how many in-flight entertainment devices are stored on board the aircraft; and
if the count of self-contained in-flight entertainment devices reserved for the commercial airline flight is larger than the default number by a difference, then bringing on board the aircraft before the commercial airline flight commences an additional number of self-contained in-flight entertainment devices at least as large as the difference.

12. The method of claim 11 wherein the pickup location is inside of a high security area.

13. The method of claim 12 wherein the pickup location is a kiosk counter or a gate counter.

14. The method of claim 11 wherein the pickup location is a counter of a rental car agency.

15. A method comprising:
determining if any number of a plurality of self-contained in-flight entertainment devices stored at a pickup location require deletion of stored audiovisual presentations and addition of other audiovisual presentations and if so, delivering a quantity of the other self-contained in-flight entertainment devices having the other audiovisual presentations stored to the pickup location for exchange with the any number of self-contained in-flight entertainment devices requiring deletion of store audiovisual presentations;
accepting payment and credential information at the pickup location in exchange for rental of a self-contained in-flight entertainment device for use on a commercial airline flight of an aircraft;
receiving the self-contained in-flight entertainment device at a drop-off location after the commercial airline flight in exchange for a return acknowledgement.

16. The method of claim 15 wherein the pickup and drop-off location is onboard the aircraft.

17. The method of claim 15 wherein the pickup and drop-off locations are at gate counters of origination and destination airports, respectively, of the commercial airline flight.
